(19) United States
(12) Patent Application Publication
(10) Pub. No.: US 2013/0334792 A1
(43) Pub. Date: Dec. 19, 2013

(54) DEVICE FOR SECURING A HITCH SLEEVE TO A HITCH

(71) Applicant: Marcia Pell, Bakersfield, CA (US)

(72) Inventor: Marcia Pell, Bakersfield, CA (US)

(21) Appl. No.: 13/524,400

(22) Filed: Jun. 15, 2012

(51) Int. Cl. B60D 1/52

(52) U.S. Cl. 280/507; 280/504

(57) ABSTRACT

A hitch comprising an outer sleeve, and an inner sleeve removably disposed within said outer sleeve and wherein each sleeve is adapted to receive a draw bar; a first end of the hitch operatively engaging a securing tab and adapted to receive at least one securing member; and the inner and outer sleeves further comprising at least one aperture adapted to receive at least one locking device to secure a draw bar. The hitch further comprising alignable apertures adapted to receive the securing member; a securing tab disposed on the inner sleeve; a securing tab disposed on the outer sleeve; or, a securing member with a flexible connection, j-hook, or a rigid connection engaging the securing tab and alignable apertures adapted to receive the securing member; or, a locking hook securably engaging at least one aperture on the inner and outer sleeves.

### FIELD OF THE INVENTION

The present invention relates to a device for removably securing an inner sleeve to an outer sleeve on a trailer hitch.

### BACKGROUND OF THE INVENTION

Traditional trailer hitches typically are made up of a receiving end or hitch receiver secured to a towing vehicle whereby a slide-in draw bar with a ball mounted on one end can be inserted on the end opposite the ball into the hitch receiver and then secured to the hitch either through a heavy duty cotter pin that is inserted through apertures aligned on the sleeve and the receiving hitch and sometimes through a redundant chain secured to the hitch and the towed vehicle. Receiving hitches are classified by weight from Class 1 to Class IV and capable of carrying a load weight of anywhere from 2,000 to over 10,000 pounds. Hitch receivers are typically offered with a square receiver opening of 1.25 inches (32 mm) (for Class I/II) or 2 inches (51 mm) (for Class III/IV/V). Some Class IV/V hitches are available in 2.5 inches (64 mm) opening sizes.

Recently, truck manufacturers have been offering trucks with hitches that are capable of receiving multiple classes of hitch receivers. For example, a hitch may have the capability of receiving both a Class I and Class II draw bar through the use of a removable hitch sleeve that fits the dimension of a Class 1 hitch and when removed, the hitch receiver can accept a Class II draw bar. The removable inner hitch sleeves are currently fastened to the larger outer sleeve through a similar cotter pin arrangement similar to how draw bars are secured to the hitch when inserted.

The problem with such an arrangement is when the hitch is not being used, many times the pins that are meant to secure the sleeves together are forgotten and when the trucks are traveling at high rates of speed the sleeves shake loose and cause road hazards leading to accidents. Accordingly, there is a need for a device that better secures a removable hitch sleeve onto a mounted vehicle hitch and better prevents inadvertent failure to secure removable hitch sleeves to a vehicle hitch.

### SUMMARY OF THE PREFERRED EMBODIMENTS

In accordance with one aspect of the present invention, A hitch comprising an outer sleeve, and an inner sleeve removably disposed within said outer sleeve and wherein each sleeve is adapted to receive a draw bar; a first end of the hitch operatively engaging a securing tab and adapted to receive at least one securing member; and the inner and outer sleeves further comprising at least one aperture adapted to receive at least one locking device to secure a draw bar.

The hitch of claim 1 wherein the inner sleeve and outer sleeves further comprise alignable apertures adapted to receive the securing member.

The hitch wherein the securing tab is disposed on the inner sleeve.

The hitch wherein the securing tab is disposed on the outer sleeve.

The hitch further comprising a securing member with a flexible connection engaging the securing tab and alignable apertures adapted to receive the securing member.

The hitch further comprising a securing member with a rigid connection engaging the securing tab and alignable apertures adapted to receive the securing member.

The hitch further comprising a securing member with a j-lock connection engaging the securing tab and alignable apertures adapted to receive the securing member;

The hitch wherein the securing member further comprises a locking hook securably engaging at least one aperture on the inner and outer sleeves.

A hitch comprising a hitch with an outer sleeve, and an inner sleeve removably disposed within said outer sleeve and wherein each is adapted to receive a draw bar; the inner sleeve and outer sleeves further comprising alignable first apertures adapted to receive at least one locking device to secure the draw bar and second alignable apertures for receiving at least one locking device when the inner sleeve is disposed within the outer sleeve; a first end of the hitch operatively engaging a securing tab; and a securing member securably engaging a securing tab and securably engaging a second end of the hitch through the second alignable apertures the hitch of claim 9 wherein the securing tab is disposed on the outer sleeve.

The hitch wherein the securing tab is disposed on the inner sleeve.

The hitch further comprising a securing member with a flexible connection engaging the securing tab and alignable apertures adapted to receive the securing member.

The hitch further comprising a securing member with a rigid connection engaging the securing tab and alignable apertures adapted to receive the securing member.

The hitch further comprising a securing member with a j-lock connection engaging the securing tab and alignable apertures adapted to receive the securing member.

### BRIEF DESCRIPTION OF THE DRAWINGS

The invention can be more readily understood by referring to the accompanying drawings in which:

FIG. 1 is a side view of a hitch with an inner hitch sleeve, an outer hitch sleeve, a fastening tab and a fastening member secured to an opposite end of the hitch.

FIG. 2 is a side view of an inner hitch sleeve removed from an outer hitch sleeve.

FIG. 3 is a front view of a hitch with an inner hitch sleeve, an outer hitch sleeve, and a fastening tab for securing a securing member to an opposite end of the hitch

FIG. 4a is a view of an inner sleeve of a hitch.

FIG. 4b is a view of an inner sleeve of a hitch

FIG. 5 is a top view of a hitch with an inner hitch sleeve, an outer hitch sleeve, a fastening tab and aligned apertures in the sleeves for a fastening member to secure the inner and outer sleeves.

FIG. 6 shows a j-hook securing member.

FIG. 7 shows a hook for securing a securing member to the inner or outer hitch sleeves.

FIG. 8a shows bottom view of an end of a securing member for securing to a tab of a hitch sleeve.

FIG. 8b shows a partial view of an end of a securing member for securing to a tab of a hitch sleeve.

FIG. 9a shows a bottom view of an end of a j-hook for securing a hook to a hitch sleeve.

FIG. 9b shows a partial view of an end of a j-hook for securing a hook of to a hitch sleeve.

FIG. 10 shows a hook for securing a hitch sleeve.

FIG. 11 is a side cross-sectional view of a hitch with an inner hitch sleeve, an outer hitch sleeve, a fastening tab and aligned apertures in the sleeves for a fastening member to secure the inner and outer sleeves.

### DETAILED DESCRIPTION OF THE PREFERRED EMBODIMENTS

A hitch is a device used to connect one thing to another. In the context of vehicles, a hitch typically comprises a permanently mounted receiving part of the hitch on the rear of the vehicle. Removably situated into the receiving part of the hitch is a ball insert which is usually square or even tubular in shape. These are usually removable and interchangeable to adapt to different sized draw bars that have a cup for inserting over the ball insert. The draw bar is usually part of a trailer system or, even permanently attached to a recreational vehicle. The ball insert has a standard locking device wherein the ball insert has apertures on both sides which align with apertures on the receiving part of the hitch when the ball insert is placed into it. Then, standard locking pins can be placed through both and a cotter pin or other fastening device locks the pin into place and preventing the removal of the ball insert.

Currently, recent hitch systems on trucks are made up of a receiving end that has a removable inner sleeve that removably secures into a permanently mounted outer sleeve. This allows for different size ball inserts to be secured into the receiving part of the hitch. However, and although the new removable inner sleeve system is secured to the receiving part of the hitch through alignable apertures, these are often not locked into place when the ball insert is removed and which causes damage to other vehicles and are also lost.

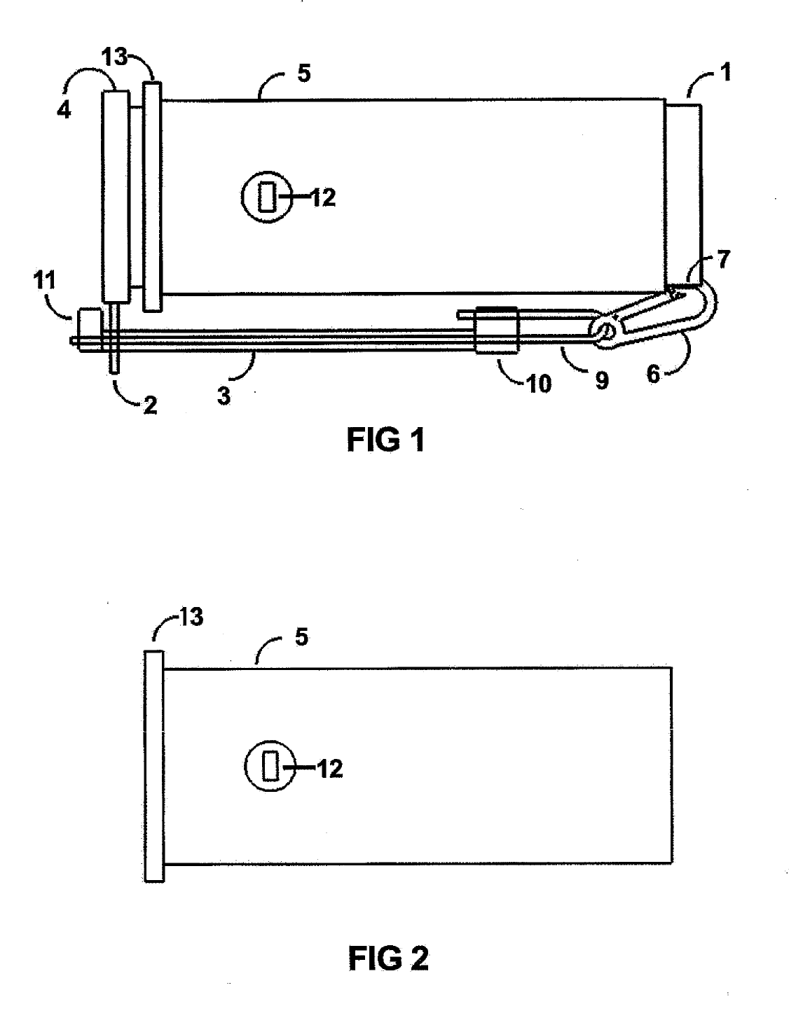

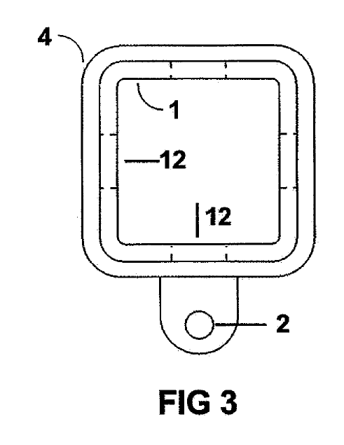

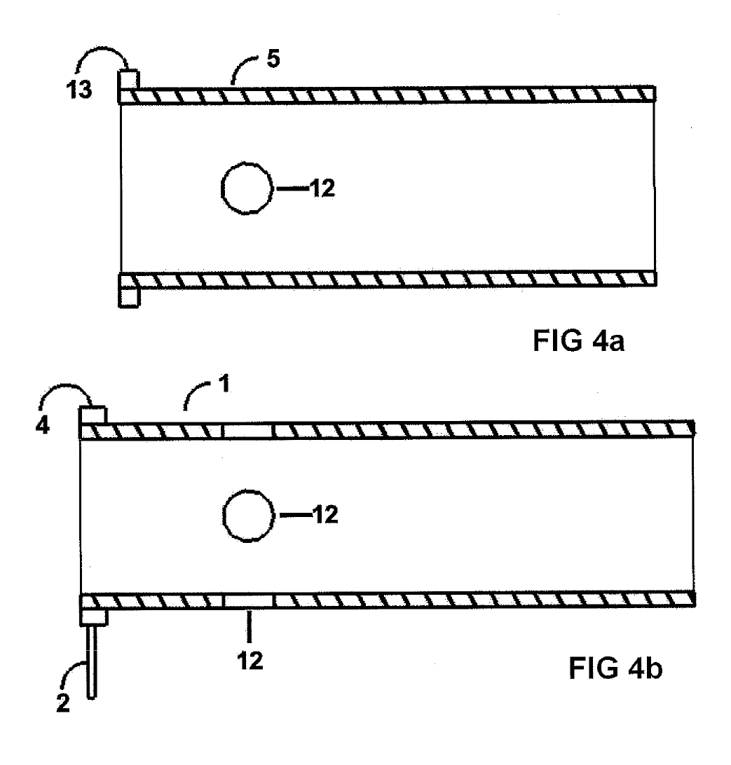

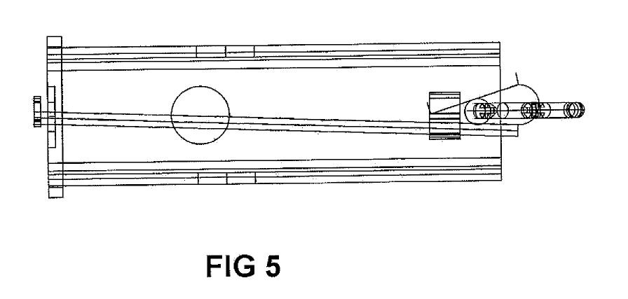

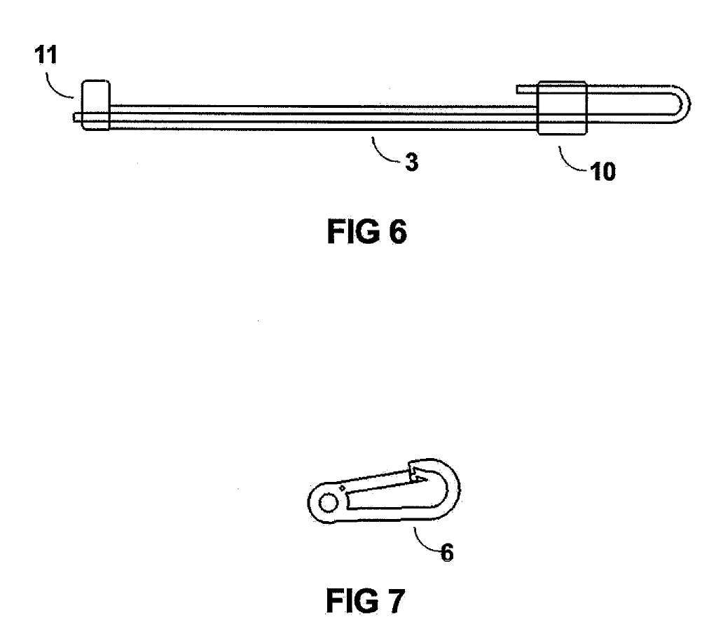

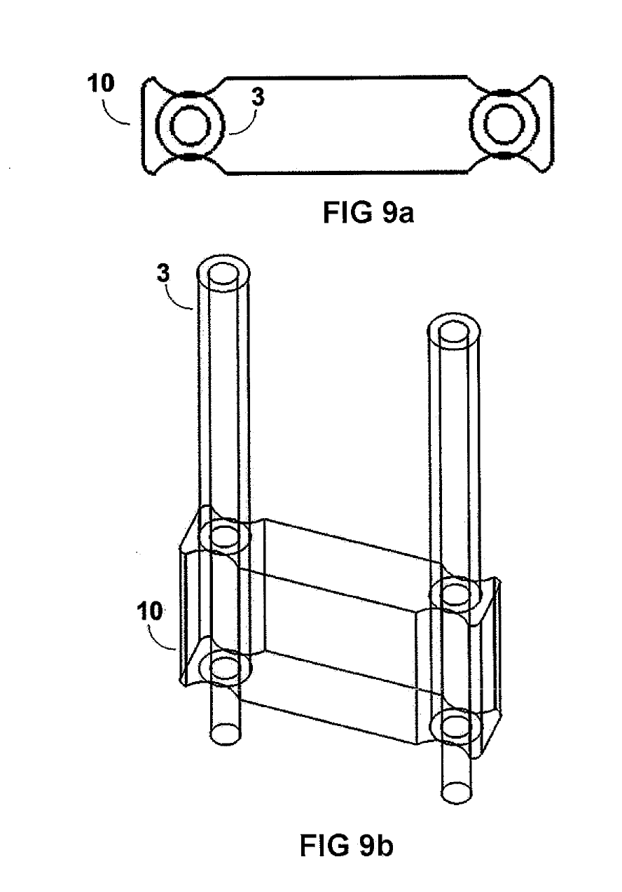

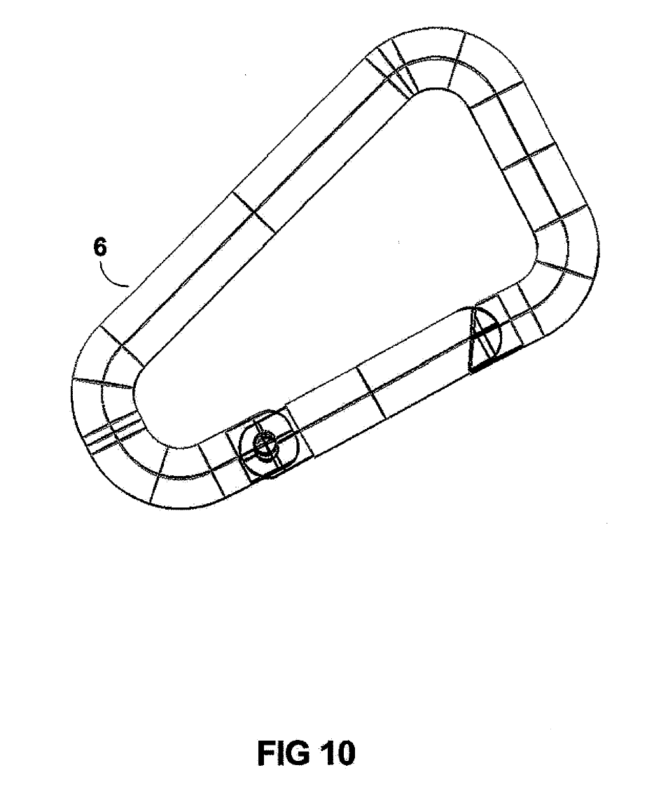

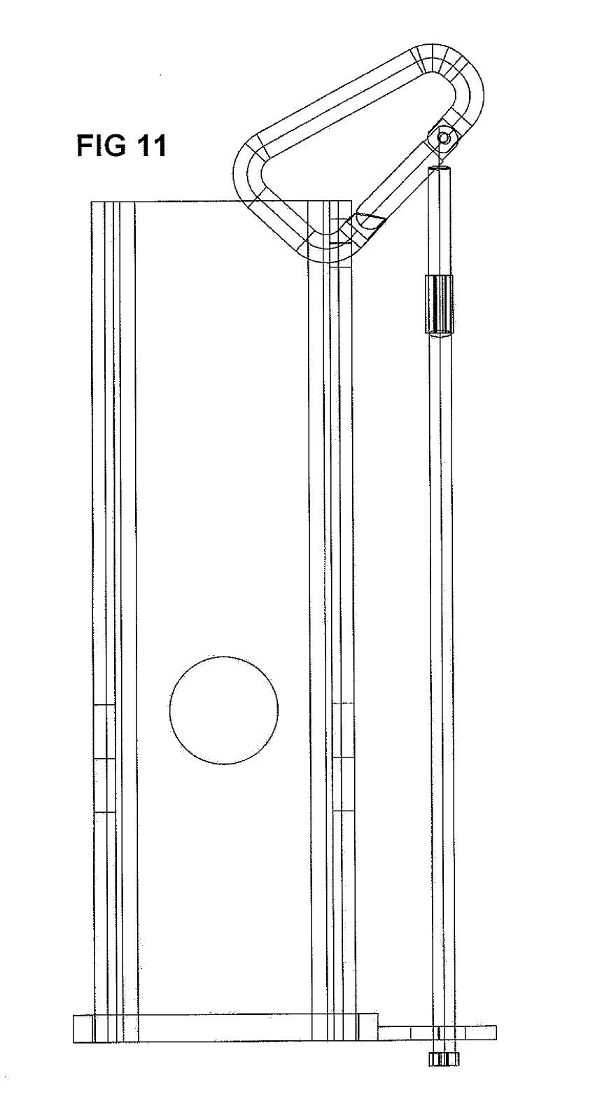

Referring to FIGS. 1 through 11, the present invention is directed to a hitch device for securing hitch sleeves on a hitch. As used herein “hitch” refers to a mounted hitch system on a vehicle comprising the components necessary for receiving a draw bar. (not shown) As used herein a “draw bar” refers to known couplings between a hauled vehicle and its hauled load and capable of being received by a hitch. Typically, a draw bar will be comprised of a ball-cup receiving system and the hitch will also comprise a ball wherein different-sized balls may be disposed and locked into place when the ball-cup of the draw bar is lowered onto the ball. As used herein, receiving balls of various sizes are typically coupled to a male hitch sleeve insert of various sizes and which can be inserted into a female hitch sleeve 1. Typically, the receiving sleeves of a hitch are permanently mounted as part of a hitch system on a vehicle. However, hitch systems also now come in various dimensions where there may be two ore more hitch sleeves that may be secured to a hitch system.

Ordinarily, and when a hitch system is not in use, a removable inner hitch sleeve 5 is secured in place through the use of a cotter pin system 12 whereby a single metal bar is inserted through apertures in the inner and outer sleeve which align when the inner sleeve 5 is fully inserted into the outer sleeve 4. Once the bar is inserted through the apertures a cotter pin is disposed through a transverse hole on an exposed end of the bar. This same system is commonly used to double as the system that secures a male hitch sleeve in place when a trailer or other vehicle is in tow or, if the hitch sleeve is left on the hitch system. However, a frequent problem with this system is that users often forget to replace the bar and pin when the male hitch sleeve is removed, leaving the inner hitch sleeve 5 susceptible to sliding out of the outer sleeve while a vehicle is in transit and causing damage to the sleeve and others.

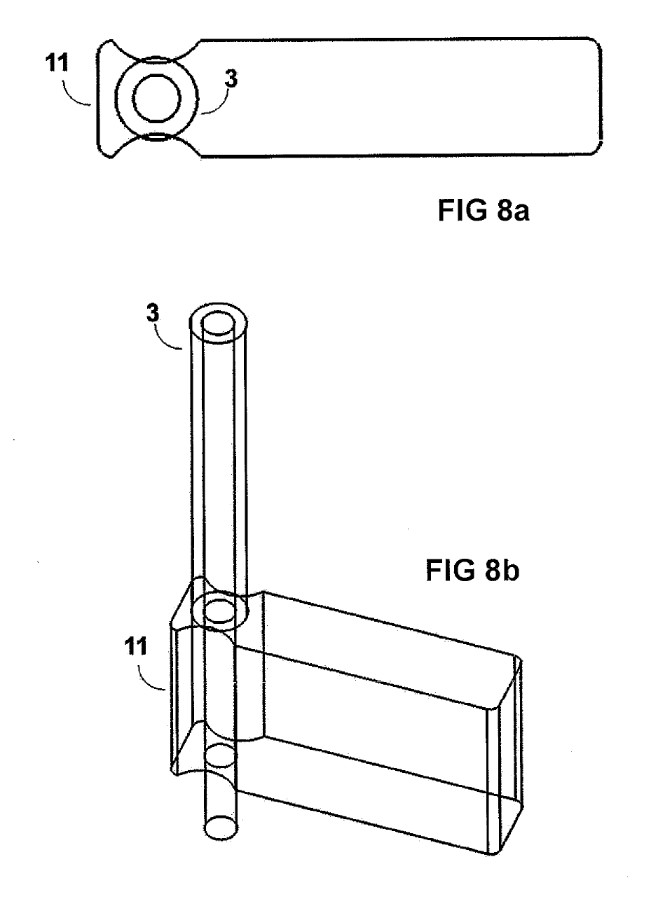

In a preferred embodiment of the present invention as exemplified in FIGS. 1 through 11 a vehicle hitch system has both a permanently mounted hitch sleeve 4 and a removable hitch sleeve 5. Fixedly mounted to the hitch system is a tab 2 having an aperture 8 through which one end of a locking bar 3 can be disposed and locked 11 to prevent removal. On a second end of hitch system is a second aperture 7 wherein a fastening member, such as a carabiner hook or other known removable fastening devices, can be disposed through and through a second end of the bar 9. FIG. 8 illustrates a j-bar locking systems used in this preferred embodiment where a second end 9 of the j-bar lock secures a hook 6 in place by being disposed through the hook and a first end is disposed inside a block 11 that secures the bar 3 from being removed from the tab 2.

In a preferred embodiment and referring again to FIGS. 1 through 11, the fastening member can secures through aligned apertures on both the inner and outer sleeves or in another preferred embodiment, through a single aperture through the end of the inner sleeve which protrudes sufficiently through the outer sleeve leaving space enough for securing member to secure itself to the inner sleeve. (See, FIG. 1) Further, in a preferred embodiment, the tab 2 may either be mounted on the inner sleeve (as shown in FIG. 1) or, can be mounted on the outer sleeve which are typically permanently mounted to the vehicle.

In another preferred embodiment a more rigid j-lock as shown in the Figures can be replaced with a flexible cable lock (not shown) that is secured to tab 2 by way of the cable being secured to an enlarged block or end that, similar to the j-lock, prevents removal from the tab 2 and, a carabiner hook 6 or other locking device that can be disposed through aligned apertures 7 on the inner sleeve 5 and outer sleeve 4.

In another preferred embodiment (not shown) a removable inner sleeve is secured into the outer sleeve through a spring tension member that snaps into apertures 12 disposed through the outer sleeve and exposed on the external portion of the hitch. When the inner hitch sleeve is inserted into the external hitch sleeve the spring tension member will remain depressed under spring tension until the tension is released when it aligns with the aperture. In this embodiment all or a portion of the spring tension member will be capable of disposing itself under spring tension through the aperture so as to prevent the inner hitch sleeve from sliding out of the hitch. In this embodiment, depressing the spring tension through a motive force such as a hand or other device while at the same time sliding the inner hitch sleeve out of the hitch enables it to be removed from the hitch.

In another preferred embodiment, more than one inner hitch sleeve within each consecutive outer hitch sleeve can accomplish the same result as described above by having similarly alignable apertures on each sleeve both on the ends for a locking mechanism to secure the sleeves or, through alignable apertures and a properly sized and disposed spring tension member.

The foregoing embodiments are merely examples of the present invention. Those skilled in the art may make numerous uses of, and departures from, such embodiments without departing from the scope of the present invention. Accordingly, the scope of the present invention is not limited to or defined by such embodiments in any way, but rather, is defined solely by the following claims.

I claim:

1. A hitch comprising:
a. An outer sleeve, and an inner sleeve removably disposed within said outer sleeve and wherein each sleeve is adapted to receive a draw bar;
b. A first end of the outer sleeve operatively engaging a securing tab permanently affixed to said first end of the outer sleeve and adapted to receive a first end of at least one removably securable securing member;
c. A second end of the outer and the inner sleeve adapted to receive a second end of the at least one removably securable securing member; and
d. The inner and outer sleeves further comprising at least one aperture adapted to receive at least one locking device to secure a draw bar.

2. The hitch of claim 1 wherein the inner sleeve and outer sleeves further comprise alignable apertures adapted to receive the securing member on their respective second ends.

3. The hitch of claim 1 wherein the securing tab is permanently affixed on the inner sleeve and not the outer sleeve.

4. (canceled)

5. The hitch of claim 2 further comprising a securing member with a flexible connection engaging the securing tab and alignable apertures adapted to receive the securing member.

6. The hitch of claim 2 further comprising a securing member with a rigid connection engaging the securing tab and alignable apertures adapted to receive the securing member.

7. The hitch of claim 2 further comprising a securing member with a j-lock connection engaging the securing tab and alignable apertures adapted to receive the securing member.

8. The hitch of claim 2 wherein the securing member further comprises a locking hook securably engaging at least one of the alignable apertures on the second ends of the inner and outer sleeves.

9. A hitch comprising:
a. A hitch with an outer sleeve, and an inner sleeve removably disposed within said outer sleeve and wherein each is adapted to receive a draw bar;
b. The inner sleeve and outer sleeves further comprising alignable first apertures adapted to receive at least one locking device to secure the draw bar and second alignable apertures for receiving at least one locking device when the inner sleeve is disposed within the outer sleeve;
c. A first end of the hitch operatively engaging a permanently affixed securing tab; and
d. A removably securable securing member securably engaging a securing tab and securably engaging a second end of the hitch through the second alignable apertures.

10. The hitch of claim 9 wherein the securing tab is disposed on the outer sleeve.

11. The hitch of claim 9 wherein the securing tab is disposed on the inner sleeve.

12. The hitch of claim 9 further comprising a securing member with a flexible connection engaging the securing tab and alignable apertures adapted to receive the securing member.

13. The hitch of claim 9 further comprising a securing member with a rigid connection engaging the securing tab and alignable apertures adapted to receive the securing member.

14. The hitch of claim 9 further comprising a securing member with a j-lock connection engaging the securing tab and alignable apertures adapted to receive the securing member.
